(19) United States
(12) Patent Application Publication
(10) Pub. No.: US 2006/0039018 A1
(43) Pub. Date: Feb. 23, 2006

(54) Apparatus and method to provide OSD

(76) Inventor: Young-chan Kim, Euiwang-si (KR)

Correspondence Address: STANZIONE & KIM, LLP, 919 18TH STREET, N.W., SUITE 440, WASHINGTON, DC, 20006, US

(21) Appl. No.: 11/208,746

(22) Filed: Aug. 23, 2005

(30) Foreign Application Priority Data
Aug. 23, 2004 (KR) 2004-66372

(51) Int. Cl. G06K 15/02

(52) U.S. Cl. 358/1.11

(57) ABSTRACT

An apparatus to provide an OSD (On Screen Display) and a method thereof. The apparatus includes a font ROM to store basic fonts, a memory to store additional fonts, a font RAM, a controller to control at least one of the basic fonts stored in the font ROM and at least one of the additional fonts stored in the memory to be copied to the font RAM, and output a font RAM address of a font to be applied to an input image, and a mixing part to read out from the font RAM the font corresponding to the font RAM address output from the controller and to apply the read font to the input image. Accordingly, when both the ROM and the RAM are employed as the font memories, an amount of address data required to read out the fonts for the OSD does not increase, and thus the OSD is provided without delay.

### CROSS-REFERENCE TO RELATED APPLICATIONS

This application claims the benefit of Korean Patent Application No. 2004-66372, filed on Aug. 23, 2004, in the Korean Intellectual Property Office, the disclosure of which is incorporated herein in its entirety by reference.

### BACKGROUND OF THE INVENTION

1. Field of the Invention

The present general inventive concept relates to an apparatus and method to provide an OSD (On Screen Display), and more particularly, to an apparatus to provide an OSD by applying fonts to an input image, and a method thereof.

2. Description of the Related Art

An OSD refers to a technology that displays on a screen an operation status, setting configurations, and a user interface of an electronic device to thereby allow a user to view them. The OSD is employed in the most electronic devices.

More specifically, the OSD is accomplished by reading out fonts from a font memory and displaying the read fonts on a screen. The font memory includes a ROM (Read Only Memory) or a RAM (Random Access Memory).

If the ROM is used as a font memory, however, only the fonts which have been previously stored in the ROM are used for the OSD. When any other fonts need to be provided for the OSD, there is no way to provide the fonts because it is impossible for the ROM to additionally store new fonts.

On the other hand, if the RAM is used as the font memory, the above problem can be solved. That is, a program and fonts for the OSD are stored in an extra program memory, and they are copied to the RAM when a power is supplied.

According to this method, a variety of fonts can be obtained for the OSD by changing the fonts stored in the program memory or adding new fonts to the program memory. However, it takes a large amount of time to read out fonts from the program memory and copy the fonts to the RAM, which results in a time loss when the apparatus for the OSD is initialized with the power supply.

### SUMMARY OF THE INVENTION

Accordingly, the present general inventive concept provides an apparatus to provide an OSD capable of constantly maintaining an amount of address data required to read out fonts for the OSD even when employing both a ROM and a RAM as a font memory, thereby providing the OSD without delay, and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an apparatus to provide an OSD (On Screen Display) including a font ROM to store basic fonts a memory to store additional fonts, a font RAM, a controller to control at least one of the basic fonts stored in the font ROM and at least one of the additional fonts stored in the memory to be copied to the font RAM and to output a font RAM address corresponding to a font to be applied to an input image, and a mixing part to read out the font corresponding to the font RAM address output from the controller from the font RAM and to apply the read out font to the input image.

The controller may control the at least one of the basic fonts stored in the font ROM and at least one of the additional fonts stored in the memory to be copied to the font RAM during one of power supply and re-set or upon receipt of a user command.

The at least one of the basic fonts to be copied from the font ROM to the font RAM and the at least one of the additional fonts to be copied from the memory to the font RAM may be designated through a selection operation.

The foregoing and/or other aspects of the present general inventive concept are also achieved by providing a method of providing an OSD performed by an apparatus to provide an OSD having a font ROM to store basic fonts, a memory to store additional fonts, and a font RAM. The method includes copying at least one of the basic fonts stored in the font ROM to the font RAM, copying at least one of the additional fonts stored in the memory to the font RAM, designating a font RAM address corresponding to a font to be applied to an input image, reading out the font corresponding to the designated font RAM addresses from the font RAM, and applying the read out font to the input image.

The copying of the at least one of the basic fonts stored in the font ROM to the font RAM and the copying of the at least one of the additional fonts stored in the memory to the font RAM may be performed during one of power supply and re-set or may be performed upon receipt of a user command.

The at least one of the basic fonts to be copied from the font ROM to the font RAM and the at least one of the additional fonts to be copied from the memory to the font RAM may be designated through a selection operation.

The foregoing and/or other aspects of the present general inventive concept are also achieved by providing an apparatus to provide an OSD including a font ROM to store basic fonts, a font RAM to store additional fonts, a controller to establish a single virtual memory by integrating at least one storing area of the font ROM with at least one storing area of the font RAM and to output a virtual memory address corresponding to a font to be applied to an input image, an address conversion part to convert the virtual memory address output from the controller into a corresponding font ROM address or a corresponding font RAM address, and a mixing part to read out a font corresponding to the font ROM address or the font RAM address output from the address conversion part, and to apply the read font to the input image.

The at least one storing area of the font ROM and the at least one storing area of the font RAM, which configure the virtual memory, may be designated through a selection operation.

The foregoing and/or other aspects of the present general inventive concept are also achieved by providing a method of providing an OSD performed by an apparatus to provide an OSD having a font ROM to store basic fonts and a font RAM to store additional fonts, the method including establishing a virtual memory by integrating at least one storing area of the font ROM with at least one storing area of the font RAM, designating a virtual memory address of a font to be applied to an input image, converting the designated virtual memory address into a corresponding font ROM address or a corresponding font RAM address, reading out from one of the font ROM and the font RAM a font corresponding to the converted font ROM address or the converted font RAM address, and applying the read out font to the input image.

The at least one storing area of the font ROM and the at least one storing areas of the font ROM, which configure the virtual memory, may be designated through a selection operation.

The foregoing and/or other aspects of the present general inventive concept are also achieved by providing an image apparatus to reproduce at least one of an image received from an external source and an image recorded on a recording medium, including a font ROM to store basic fonts, a memory to store additional fonts, a font RAM, a controller to control at least one of the basic fonts stored in the font ROM and at least one of the additional fonts stored in the memory to be copied to the font RAM and to output a font RAM address corresponding to a font to be applied to an input image, and a mixing part to read out the font corresponding to the font RAM address output from the controller from the font RAM and to apply the read font to the input image.

The foregoing and/or other aspects of the present general inventive concept are also achieved by providing an image apparatus to reproduce at least one of an image received from an external source and an image recorded on a recording medium, including a font ROM to store basic fonts, a font RAM to store additional fonts, a controller to establish a single virtual memory by integrating at least one storing area of the font ROM with at least one storing area of the font RAM and to output a virtual memory address of a font to be applied to the input image, an address conversion part to convert the virtual memory address output from the controller into a corresponding font ROM address or a corresponding font RAM address, and a mixing part to read out a font corresponding to one of the font ROM address and the font RAM output from the address conversion part from one of the font ROM and the font RAM.

The foregoing and/or other aspects of the present general inventive concept are also achieved by providing an OSD (On Screen Display) generator, including a display memory to store fonts to be applied to an input image, and a controller to designate an address for a font of fonts stored in at least one non-volatile memory and fonts stored in at least one volatile memory that is to be applied to the input image, and to store the font to be applied to the input image to the display memory. An amount of address data designated by the controller is less than the total amount of address data assigned to the at least one non-volatile memory and the at least one volatile memory.

The amount of address data designated by the controller may be one of the total amount of address data assigned to the one non-volatile memory and the total amount of address data assigned to the one volatile memory.

The amount of address data designated by the controller may be 1 byte.

The controller may control a portion of basic fonts stored in the non-volatile memory and a portion of additional fonts stored in the program memory to be copied to the volatile memory, and designate a volatile memory address for the font to be applied to the input image and thereby store the font to the display image.

The controller may establish a virtual memory by integrating a part of storing areas of the non-volatile memory with a part of storing areas of the volatile memory, and designate a virtual memory address for the font to be applied to the input image and thereby store the font to the display memory.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating an apparatus to provide an OSD according to an embodiment of the present general inventive concept;

FIG. 2 is a flowchart illustrating a method of providing an OSD according to an embodiment of the present general inventive concept;

FIGS. 3A, 3B, and 3C are views illustrating a font ROM, a program memory, and a font RAM, respectively, before copying operations of FIG. 2;

FIG. 3D is a view illustrating the font RAM after the copying operations of FIG. 2;

FIG. 4 is a block diagram illustrating an apparatus to provide an OSD according to another embodiment of the present general inventive concept;

FIG. 5 is a flowchart illustrating a method of providing an OSD according to another embodiment of the present general inventive concept;

FIG. 6A is a view illustrating a font ROM and a font RAM after copying operations of FIG. 5;

FIG. 6B is a view illustrating a single virtual memory established by integrating at least one storing area of the font ROM of FIG. 6A with at least one storing area of the font RAM of FIG. 6A; and

FIG. 7 is a block diagram illustrating an OSD generator according to still another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

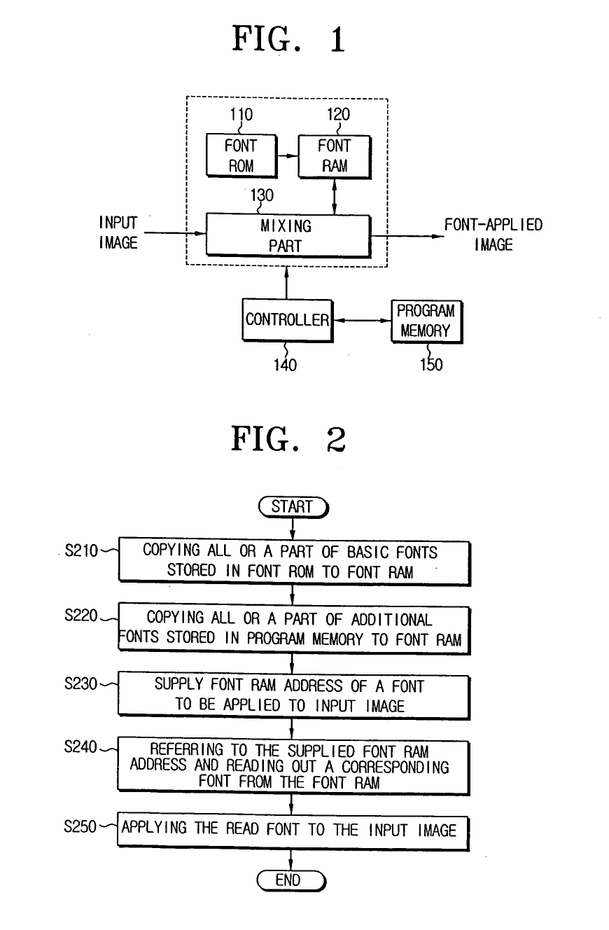

FIG. 1 is a block diagram illustrating an apparatus to provide an OSD (On Screen Display) according to an embodiment of the present general inventive concept. The apparatus to provide the OSD applies fonts to an input image to output a font-applied image. The fonts can include characters, figures, symbols, numerical figures, and images, which are applied to the input image by the apparatus of FIG. 1.

Referring to FIG. 1, the apparatus to provide the OSD according to the present embodiment includes a font ROM (Read Only Memory) 110, a font RAM (Random Access Memory) 120, a mixing part 130, a controller 140, and a program memory 150.

The font ROM 110 is a non-volatile memory and stores basic fonts that are often required for the OSD.

The program memory 150 stores a program required to operate the OSD and additional fonts that may be required for the OSD in addition to the basic fonts.

Since the font ROM 110 is the non-volatile memory, it may be impossible for the font ROM 110 to store fonts in addition to the basic fonts stored in the font ROM 110. Therefore, if the additional fonts are required for the OSD, the additional fonts must be stored in the program memory 150.

The controller 140 controls the basic fonts stored in the font ROM 110 to be copied to the font RAM 120. Also, the controller 140 controls the additional fonts stored in the program memory 150 to be copied to the font RAM 120.

The controller 140 controls the mixing part 130 to output a font-applied image. More specifically, the controller 140 designates a font among the fonts stored in the font RAM 120 to apply the designated font to an input image. The fonts stored in the font RAM 120 are the basic fonts and the additional fonts that have been copied from the font ROM 110 and the program memory 150, respectively, to the font RAM 120. In order for the mixing part 130 to output the font-applied image, the controller 140 supplies a font RAM address corresponding to the font to be applied to the input image to the mixing part 130.

The mixing part 130 reads out the font from the font RAM 120 corresponding to the font RAM address supplied by the controller 140. The mixing part 130 applies the read out font to the input image. Accordingly, the mixing part 130 generates and outputs the font-applied image.

FIG. 2 is a flowchart illustrating a method of providing an OSD according to an embodiment of the present general inventive concept.

Referring to FIGS. 1 and 2, the controller 140 controls the basic fonts stored in the font ROM 110 to be copied to the font RAM 120 at operation S210. The controller may control all or a portion of the basic fonts to be copied from the font ROM 110 to the font RAM 120.

When a portion of the basic fonts are copied, the basic fonts to be copied and the corresponding font RAM addresses may be designated through a selection of a user or other source. Accordingly, the user or the other selection source can exclude basic fonts that are unnecessary for the OSD and copy only necessary basic fonts to the font RAM 120.

Since the copying of the fonts from the font ROM 110 to the font RAM 120 can be implemented at a hardware level, the copying can be done rapidly.

The controller 140 controls the additional fonts stored in the program memory 150 to be copied to the font RAM 120 at operation S220. The controller 140 may control all or a portion of the additional fonts to be copied from the program memory 150 to the font RAM 120.

When a portion of the additional fonts are copied, the additional fonts to be copied and the corresponding font RAM addresses can be designated through a selection of a user or other source. Accordingly, the user or other selection source can exclude additional fonts that are unnecessary for the OSD and copy only additional fonts necessary for the OSD to the font RAM 120.

A time to begin operations S210 and S220 is not limited to a specified time. That is, operations S210 and S220 can be performed during a power supply or re-set. Also, operations S210 and 220 can be performed upon receipt of a user's command.

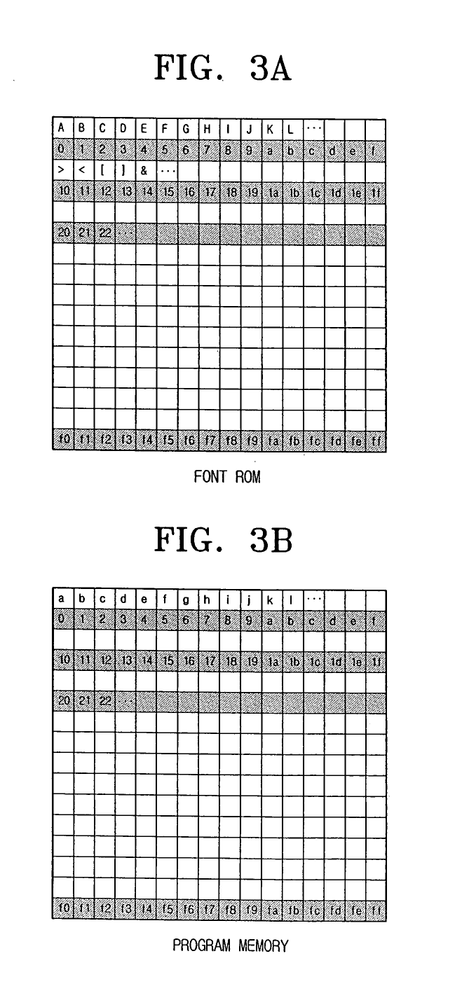

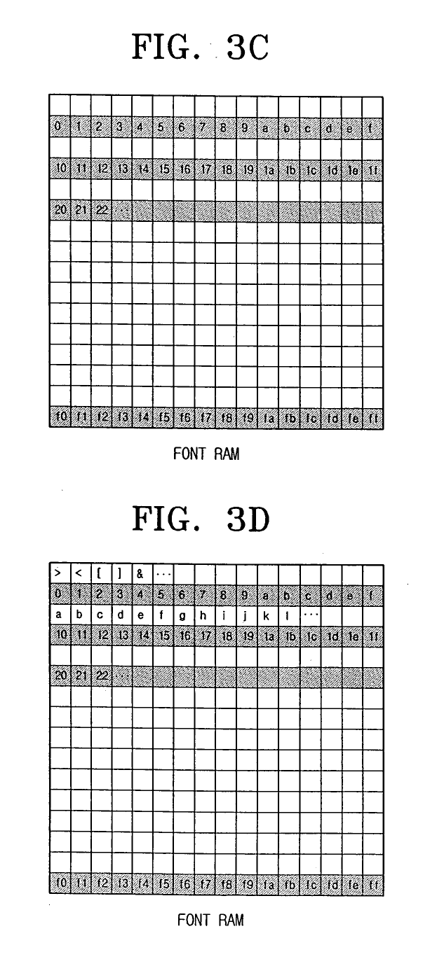

FIGS. 3A, 3B, and 3C illustrate examples of the font ROM 110, the program memory 150, and the font RAM 120, respectively, before operations S210 and S220. Referring to FIG. 3A, as basic fonts, English capital letters, such as “A”, “B”, “C”, and so on, can be stored to addresses “0”, “1”, “2”, and so on of the font ROM 110, and special characters, such as “>”, “<” “[”, “]” “&”, and so on, can be stored to addresses “10”, “11”, “12”, “13”, “14”, and so on. Referring to FIG. 3B, as additional fonts, English lower case letters, such as “a”, “b”, “c”, and so on, can be stored to addresses “0”, “1”, “2”, and so on of the program memory 150. Referring to FIG. 3C, no fonts are stored in the font ROM 120 before operations S210 and S220 are performed.

FIG. 3D illustrates the font RAM 120 after operations S210 and S220. Referring to FIG. 3D, the special characters, such as “<”, “>”, “[”, “]”, “&”, stored in the font ROM 110 can be copied to addresses “0”, “1”, “2”, “3”, “4”, and so on of the font RAM 120. Also, the English small letters, such as “a”, “b”, “c”, and so on, stored in the program memory 150 can be copied to addresses “10”, “11”, “12”, and so on of the font RAM 120.

As described above, at operations S210 and S220, the basic fonts and the additional fonts that are necessary for the OSD are copied to the font RAM 120.

Returning to FIG. 2, when a font to be applied to an input image is required for the operation of OSD, the controller 140 supplies a font RAM address corresponding to the font to the mixing part 130 at operation S230.

If the font RAM 120 is provided with 256 (=2⁸) storage areas (from the address “0” to the address “ff”) as illustrated in FIG. 3D, the addresses to be supplied to the mixing part 130 at operation S230 can be expressed by 1 byte. Although the apparatus to provide the OSD according to the present embodiment employs two font memories, i.e., the font ROM 110 and the font RAM 120, an amount of address data required to read out the fonts is the same as in a case in which a single font memory is employed. This is because only the necessary fonts for the OSD are copied to the font RAM 120 at operations S210 and S220.

The mixing part 130 reads out corresponding fonts from the font RAM 120 by referring to the font RAM addresses supplied from the controller 140 at operation S240. The mixing part 130 then applies the read out fonts to the input image at operation S250. Accordingly, the mixing part 130 outputs a font-applied image.

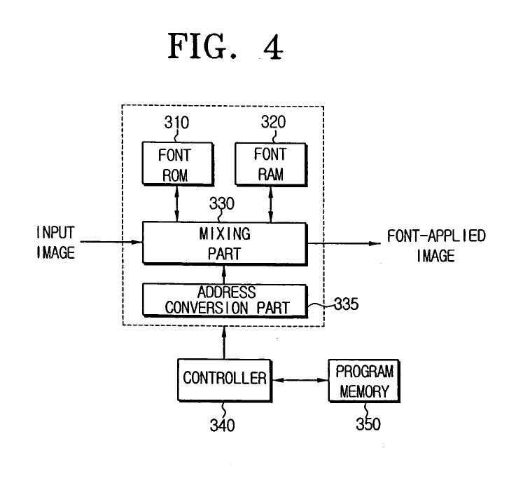

FIG. 4 is a block diagram illustrating an apparatus to provide an OSD according to another embodiment of the present general inventive concept. Referring to FIG. 4, the apparatus to provide the OSD includes a font ROM 310, a font RAM 320, a mixing part 330, an address conversion part 335, a controller 340, and a program memory 350.

The font ROM 310 is a non-volatile memory and stores basic fonts. The program memory 350 stores a program required for the operation of the OSD and additional fonts.

The controller 340 controls the additional fonts stored in the program memory 350 to be copied to the font RAM 320. The controller 340 establishes a single virtual memory by integrating a portion of the font ROM 310 with a portion of the font RAM 320. The controller 340 assigns new addresses to storage areas of the established virtual memory.

The controller 340 designates a font among the fonts stored in the virtual memory, i.e., among the basic fonts and additional fonts respectively stored in a part of the storage areas of the font ROM 310 and a part of the storage areas of the font RAM 320 to apply the font to an input image. In order for the mixing part 130 to output a font-applied image, the controller 340 supplies a virtual memory address of the font to be applied to the input image to the address conversion part 335.

The address conversion part 335 receives the virtual memory address from the controller 340, and converts the virtual addresses into a corresponding font ROM address or a corresponding font RAM address and supplies the converted address to the mixing part 330.

The mixing part 330 refers to the font ROM addresses or the font RAM addresses supplied from the address conversion part 335 and reads out a corresponding font from the font ROM 310 or the font RAM 320, respectively. The mixing part 330 supplies the read font to an input image. Accordingly, the mixing part 330 generates and outputs a font-applied image.

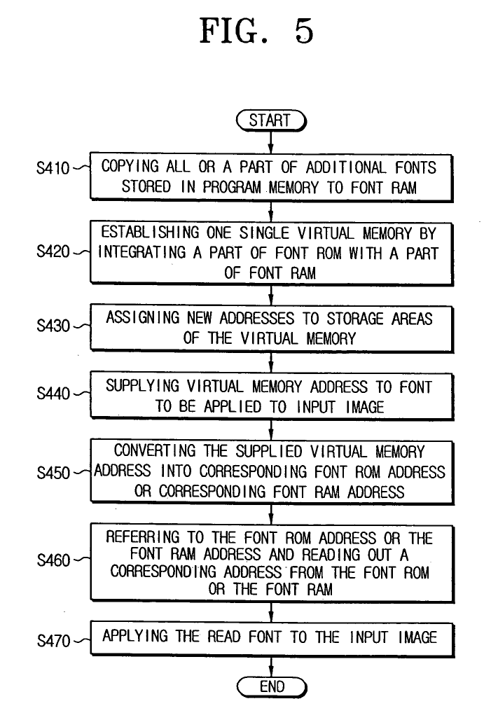

FIG. 5 is a flowchart illustrating a method of providing an OSD according to another embodiment of the present general inventive concept.

Referring to FIGS. 4 and 5, the controller 340 controls the additional fonts stored in the program memory 350 to be copied to the font RAM 320 at operation S410. The controller 340 may control all or a portion of the additional fonts to be copied to the font RAM 320.

The controller 340 then establishes a single virtual memory by integrating a portion of the font ROM 310 with a portion of the font RAM 320 at operation S420. A user can designate which storage areas of the font ROM 310 and which storage areas of the font RAM 320 are integrated to establish the single virtual memory. Accordingly, the user can exclude basic fonts and additional fonts that are unnecessary for the OSD and establish the virtual memory storing only the necessary basic fonts and additional fonts.

The controller 340 assigns new addresses to storage areas of the established virtual memory at operation S430.

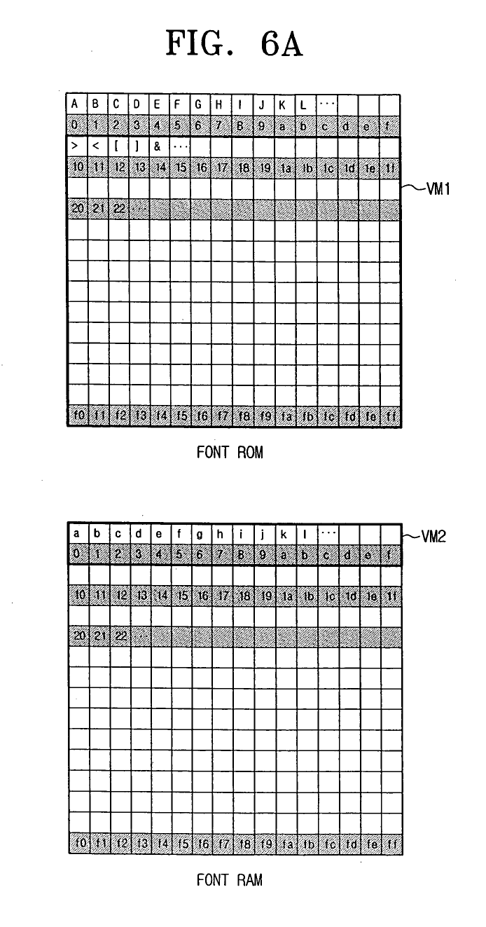

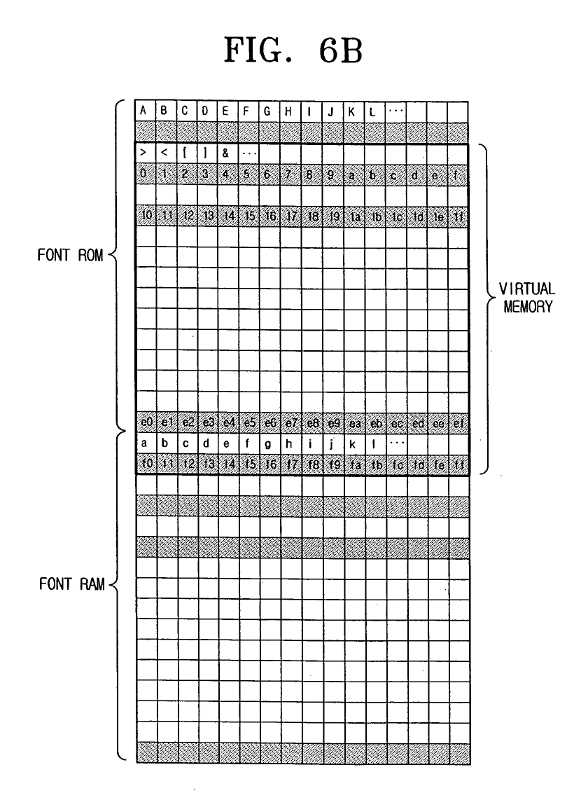

FIG. 6A is a view illustrating the font ROM 310 and the font RAM 320 after operation S410. The virtual memory is established by integrating storage areas VM1 (from the address “10” to the address “ff)” of the font ROM 310 with storage areas VM2 (from the address “0” to the address “f”) of the font RAM 320. The storage areas VM1 and VM2 are boxed in the bold lines in FIG. 6A. The fonts existing within the box are designated as necessary for the OSD.

FIG. 6B is a view illustrating the single virtual memory established by integrating the storage areas VM1 of the font ROM 310 with the storage areas VM2 of the font ROM 320 of FIG. 6A. As illustrated in FIG. 6B, the virtual memory includes of the storage areas VM1 of the font ROM 310 and the storage areas VM2 of the font ROM 320, and its storage areas are assigned with new virtual addresses from the address “0” to the address “ff”.

As described above, at operations S420 and S430 the virtual memory that stores the basic fonts and the additional font necessary for the OSD and the virtual memory addresses are established.

Returning to FIG. 5, when a font needs to be applied to an input image for the operation of OSD, the controller 340 supplies a virtual memory address corresponding to the font to the address conversion part 335 at operation S440.

If the virtual memory is provided with 256(=2⁸) storage areas of from the address “0” to the address “ff” as illustrated in FIG. 6B, the addresses to be supplied to the address conversion part 335 at operation S440 can be expressed by 1 byte. Although the apparatus to provide the OSD according to the present embodiment employs two font memories, i.e., the font ROM 310 and the font ROM 320, an amount of address data required to read out the fonts is the same as in a case in which one single font memory is employed. This is possible because one single virtual memory is established by integrating the storage areas of the font ROM 310 with the storage areas of the font RAM 320 to store the fonts necessary for the operation of OSD.

The address conversion part 335 converts the virtual memory address received from the controller 340 to a corresponding font ROM address or a corresponding font RAM address at operation S450, and then supplies the converted addresses to the mixing part 330.

The mixing part 330 refers to the addresses supplied from the address conversion part 335 and reads out corresponding fonts at operation S460. More specifically, when the font ROM address is supplied from the address conversion part 335, the mixing part 330 reads out the corresponding font from the font ROM 310. When the font RAM address is supplied from the address conversion part 335, the mixing part 330 reads out the corresponding font from the font RAM 320.

Next, the mixing part 330 applies the read out font to the input image at operation S470. Accordingly, the mixing part 330 generates and outputs a font-applied image.

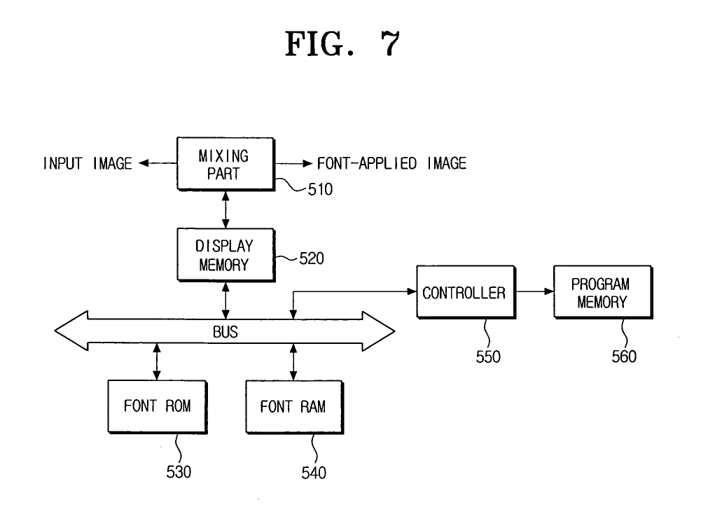

FIG. 7 is a block diagram illustrating an OSD generator according to sill another embodiment of the present general inventive concept. Referring to FIG. 7, the OSD generator includes a mixing part 510, a display memory 520, a font ROM 530, a font RAM 540, a controller 550, and a program memory 560.

Since the font ROM 530, the font RAM 540, and the program memory 560 are identical to those of FIG. 1, their descriptions will be omitted.

The display memory 520 stores fonts to be applied to an input image in corresponding locations. The mixing part 510 applies the fonts stored in the display memory 520 to the input image, thereby generating a font-applied image.

The controller 550 designates an address for a font among the fonts stored in the font ROM 530 or the font RAM 540 that is to be applied to the input image, and thereby stores the font to a corresponding location of the display memory 520.

An amount of address data designated by the controller 550 is less than the total amount of address data assigned to the font ROM 530 and the font RAM 540. For example, if the font ROM 530 and the font RAM 540 are provided with 256(=2⁸) storage areas of from the address “0” to the address “ff”, respectively, the total amount of address data assigned to both the font ROM 530 and the font RAM 540 is 512 bit. In this case, the amount of address data designated by the controller 550 is less than 512 bit. That is, the address designated by the controller 550 can be expressed by data of less than 512 bit.

Of course, the amount of address data designated by the controller 550 may be equal to or less than an amount of address data (256 bit=1 byte) assigned to the font ROM 530 or an amount of address data (1 byte) assigned to the font RAM 540. The amount of address data can be set if necessary.

According to one method in order to decrease the amount of address data, only the basic fonts and additional fonts are copied to the font RAM 540.

More specifically, the controller 550 controls all or a portion of the basic fonts stored in the font ROM 530 to be copied to the font RAM 540, and controls all or a portion of the additional fonts stored in the program memory 560 to be copied to the font RAM 540. Since additional descriptions thereof are analogous to those of FIGS. 3A to 3D, they will be omitted.

When a font needs to be applied to an input image for the operation of OSD, the controller 550 designates a font RAM address for the font to be applied to the input image, and thereby stores the font to a corresponding location of the display memory 520. Then, the mixing part 510 applies the fonts stored in the display memory 520 to the input image, thereby generating a font-applied image.

According to another method in order to decrease the amount of address data, a virtual memory is established to store basic fonts and additional fonts.

More specifically, the controller 550 controls all or a portion of additional fonts stored in the program memory 560 to be copied to the font RAM 540, and establishes a single virtual memory by integrating a part of storing areas of the font ROM 530 with a part of storing areas of the font RAM 540 and assigns a new address to a storing area of the established virtual memory. Since additional descriptions about the virtual memory are analogous to those of the virtual memory of FIGS. 6A and 6B, they will be omitted.

If a font needs to be applied to an input image for the operation of OSD, the controller 550 designates a virtual memory address for the font to be applied to the input image, and thereby stores the font to a corresponding location of the display memory 520. Then, the mixing part 510 applies the fonts stored in the display memory 520 to the input image, thereby generating a font-applied image.

The OSD generator of FIG. 7 is provided with one font ROM 530 and one font RAM 540. However, the present general inventive concept can be applied if the OSD generator is provided with two or more font ROMs 530 and/or two or more font RAMs 540.

That is, even if a plurality of font ROMs 530 or a plurality of font RAMs 540 are provided in the OSD generator, the amount of address data can be decreased by the method i) copying only the necessary basic fonts and additional font to one of the font RAMs 540 or ii) establishing a virtual memory to store the necessary basic fonts and the additional fonts.

In the above embodiments, the basic fonts can include English capital letters and special characters, and the additional fonts can include English lower case letters. As illustrated in FIGS. 3D and 6B, the fonts required for the OSD can be the special characters and the English lower case letters. However, this should not be considered as limiting. Accordingly, there is no limitation to the kinds of basic fonts, additional fonts and fonts required for the OSD. If the fonts belonging to the same kind but having different styles, such as italic type English capital letters and gothic type English capital letters, are used as basic fonts and the additional fonts, the embodiments of the present general inventive concept can be applied.

An apparatus to provide an osb and a method thereof, according to various embodiments of the present general inventive concept, can be applied to an image apparatus that reproduces an image received from an external source or recorded on a recording medium. The image apparatus can include a TV, a monitor, a set-top box, a DVD (Digital Video Disk) player, a VCD (Video Compact Disk) player, a VCR (Video Cassette Recorder), a mobile phone, a PDA (Personal Digital Assistant), etc.

According to various embodiments of the present general inventive concept, when an apparatus to provide an OSD employs both a ROM and a RAM as font memories, an amount of address data used to read out the fonts does not increase. Subsequently, since an amount of data to be processed does not increase, an apparatus to provide an OSD can provide an OSD in a timely manner.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to provide an OSD (On Screen Display) comprising:
a font ROM to store basic fonts;
a memory to store additional fonts;
a font RAM;
a controller to control at least one of the basic fonts stored in the font ROM and at least one of the additional fonts stored in the memory to be copied to the font RAM, and to output a font RAM address corresponding to a font to be applied to an input image; and
a mixing part to read out from the font RAM the font corresponding to the font RAM address output from the controller and to apply the read font to the input image.

2. The apparatus as claimed in claim 1, wherein the controller controls the at least one of the basic fonts stored in the font ROM and at least one of the additional fonts stored in the memory to be copied to the font RAM during one of power supply and re-set, or upon receipt of a user command.

3. The apparatus as claimed in claim 1, wherein the at least one of the basic fonts to be copied from the font ROM to the font RAM and the at least one of the additional fonts to be copied from the memory to the font RAM are designated through a selection operation.

4. The apparatus as claimed in claim 3, wherein the selection operation is performed by a user.

5. The apparatus as claimed in claim 1, wherein the memory comprises a program memory to store the additional fonts and to store a program to generate the OSD.

6. A method of providing an OSD performed by an apparatus to provide an OSD comprising a font ROM to store basic fonts, a memory to store additional fonts, and a font RAM, the method comprising:
copying at least one of the basic fonts stored in the font ROM to the font RAM;
copying at least one of the additional fonts stored in the memory to the font RAM;
designating a font RAM address corresponding to a font to be applied to an input image;
reading out the font corresponding to the designated font RAM addresses from the font RAM; and
applying the read out font to the input image.

7. The method as claimed in claim 6, wherein the copying of the at least one of the basic fonts stored in the font ROM to the font RAM and the copying of the at least one of the additional fonts stored in the memory to the font RAM are performed during one of power supply and re-set, or are performed upon receipt of a user command.

8. The method as claimed in claim 6, wherein the at least one of the basic fonts to be copied from the font ROM to the font RAM and the at least one of the additional fonts to be copied from the memory to the font RAM are designated through a selection operation.

9. An apparatus to provide an OSD comprising:
a font ROM to store basic fonts;
a font RAM to store additional fonts;
a controller to establish a single virtual memory by integrating at least one storing area of the font ROM with at least one storing area of the font RAM, and to output a virtual memory address corresponding to a font to be applied to an input image;
an address conversion part to convert the virtual memory address output from the controller into a corresponding font ROM address or a corresponding font RAM address; and
a mixing part to read out from the font ROM or the font RAM a font corresponding to the font ROM address or the font RAM address output from the address conversion part and to apply the read out font to the input image.

10. The apparatus as claimed in claim 9, wherein the at least one storing area of the font ROM and the at least one storing area of the font RAM, which configure the virtual memory, are designated through a selection operation.

11. The apparatus as claimed in claim 10, wherein the selection operation is performed by a user.

12. A method of providing an OSD performed by an apparatus to provide an OSD comprising a font ROM to store basic fonts and a font RAM to store additional fonts, the method comprising:
establishing a virtual memory by integrating at least one storing area of the font ROM with at least one storing area of the font RAM;
designating a virtual memory address of a font to be applied to an input image;
converting the designated virtual memory address into a corresponding font ROM address or a corresponding font RAM address;
reading out from one of the font ROM and the font RAM a font corresponding to the converted font ROM address or the converted font RAM address; and
applying the read out font to the input image.

13. The method as claimed in claim 12, wherein the at least one storing area of the font ROM and the at least one storing areas of the font ROM, which configure the virtual memory, are designated through a selection operation.

14. An image apparatus to reproduce at least one of an image received from an external source and an image recorded on a recording medium, the image apparatus comprising:
a font ROM to store basic fonts;
a memory to store additional fonts;
a font RAM;
a controller to control at least one of the basic fonts stored in the font ROM and at least one of the additional fonts stored in the memory to be copied to the font RAM, and to output a font RAM address corresponding to a font to be applied to an input image; and
a mixing part to read out a font corresponding to the font RAM address output from the controller from the font RAM, and to apply the read out font to the input image.

15. An image apparatus to reproduce at least one of an image received from an external source and an image recorded on a recording medium, the image apparatus comprising:
a font ROM to store basic fonts;
a font RAM to store additional fonts;
a controller to establish a single virtual memory by integrating at least one storing area of the font ROM with at least one storing area of the font RAM, and to output a virtual memory address of a font to be applied to the input image;
an address conversion part to convert the virtual memory address output from the controller into a corresponding font ROM address or a corresponding font RAM address; and
a mixing part to read out a font corresponding to one of the font ROM address and the font RAM output from the address conversion part from one of the font ROM and the font RAM.

16. An apparatus to provide an on screen display (OSD), comprising:
a font ROM to store predetermined fonts;
a font RAM to copy one or more of the predetermined fonts thereto from the font ROM and to copy selected additional fonts thereto from an external source; and
a font applying unit to determine which of the fonts copied to the font RAM are required to display an input image, to determine RAM addresses corresponding to the required fonts, to read out the required fonts from the font RAM using the corresponding font RAM addresses, and to display the input image using the read out fonts.

17. The apparatus as claimed in claim 16, wherein the predetermined fonts stored in the font ROM comprise basic fonts used by the font applying unit to display an image.

18. The apparatus as claimed in claim 16, wherein the one or more of the predetermined fonts and the selected additional fonts are designated through a selection operation.

19. The apparatus as claimed in claim 18, wherein the selection operation is performed by a user.

20. The apparatus as claimed in claim 16, wherein the external source comprises a program memory to store the additional fonts and to store a program to generate the OSD.

21. An apparatus to provide an on screen display (OSD), comprising:
a font ROM to store predetermined basic fonts at font ROM addresses;
a font RAM to store selected additional fonts at font RAM addresses; and
a virtual memory formed by integrating a designated portion of the font ROM storing one or more of the predetermined basic fonts with a designated portion of the font RAM storing one or more of the selected additional fonts; and
a font applying unit to determine which of the fonts of the virtual memory are required to display an input image, to determine virtual memory addresses corresponding to the required fonts, to read out the required fonts using the corresponding virtual memory addresses, and to apply the read out fonts to the input image.

22. The apparatus as claimed in claim 21, wherein the font applying unit translates the virtual memory addresses of each of the required fonts to one of a corresponding font ROM address and a corresponding font RAM address and reads out the respective required font from one of the font ROM and the font RAM using the one of the corresponding font ROM address and the corresponding font RAM address.

23. The apparatus as claimed in claim 21, wherein the designated portions of the font ROM and the font RAM are designated through a selection operation to select the one or more predetermined basic fonts and the one or more selected additional fonts to be stored in the virtual memory.

24. The apparatus as claimed in claim 23, wherein the selection operation is performed by a user.

25. A method of providing an on screen display (OSD), comprising:
copying fonts from a ROM and a program memory to a RAM;
determining which of the fonts copied to the RAM are required to be applied to an input image and determining RAM addresses corresponding to the required fonts; and
reading out the required fonts from the RAM using the corresponding RAM addresses to apply the read out fonts to the input image.

26. The method as claimed in claim 26, wherein the copying of the fonts from the ROM and the program memory to the RAM comprises:
selecting desired fonts from a plurality of basic fonts stored in the ROM and a plurality of additional fonts stored in the program memory; and
copying the desired fonts from the ROM and the program memory to the RAM.

27. A method of providing an on screen display (OSD), comprising:
storing predetermined fonts in a ROM and additional fonts in a RAM;
integrating a portion of the ROM storing one or more of the predetermined fonts and a portion of the RAM storing one or more of the additional fonts to form a virtual memory;
determining which of the fonts of the virtual memory are required to be applied to an input image and determining virtual memory addresses corresponding to the required fonts; and
reading out the required fonts using the corresponding virtual memory addresses and applying the read out fonts to the input image.

28. The method as claimed in claim 27, wherein the reading out of the required fonts using the corresponding virtual memory addresses comprises:
translating the virtual memory addresses corresponding to each of the required fonts into one of a corresponding ROM address and a corresponding RAM address; and
reading out each of the required fonts from one of the ROM and the RAM using the one of the corresponding ROM address and the corresponding RAM address.

29. The method as claimed in claim 27, wherein the integrating of the portion of the ROM storing the one or more of the predetermined fonts and the portion of the RAM storing the one or more of the additional fonts comprises:
selecting desired fonts from the predetermined fonts stored in the ROM and the additional fonts stored in the RAM; and
integrating portions of the ROM and the RAM storing the selected desired fonts.

30. A computer readable recording medium containing a method of providing an on screen display (OSD), the method comprising:
copying at least one of basic fonts stored in a font ROM to a font RAM;
copying at least one of additional fonts stored in a memory to the font RAM;
designating a font RAM address corresponding to a font to be applied to an input image;
reading out the font corresponding to the designated font RAM addresses from the font RAM; and
applying the read out font to an input image.

31. A computer readable recording medium containing a method of providing an on screen display (OSD), the method comprising:
establishing a virtual memory by integrating at least one storing area of a font ROM with at least one storing area of a font RAM;
designating a virtual memory address of a font to be applied to an input image;
converting the designated virtual memory address into a corresponding font ROM address or a corresponding font RAM address;
reading out from one of the font ROM and the font RAM a font corresponding to the converted font ROM address or the font RAM address; and
applying the read out font to the input image.

32. A computer readable recording medium containing a method of providing an on screen display (OSD), the method comprising:
copying fonts from a ROM and a program memory to a RAM;
determining which of the fonts copied to the RAM are required to be applied to an input image and determining RAM addresses corresponding to the required fonts; and
reading out the required fonts from the RAM using the corresponding RAM addresses to apply the read out fonts to the input image.

33. A computer readable recording medium containing a method of providing an on screen display (OSD), the method comprising:
storing predetermined fonts in a ROM and additional fonts in a RAM;
integrating a portion of the ROM storing one or more of the predetermined fonts and a portion of the RAM storing one or more of the additional fonts to form a virtual memory;
determining which of the fonts of the virtual memory are required to be applied to an input image and determining virtual memory addresses corresponding to the required fonts; and
reading out the required fonts using the corresponding virtual memory addresses and applying the read out fonts to the input image.

34. An OSD (On Screen Display) generator comprising:
a display memory to store fonts to be applied to an input image; and
a controller to designate an address for a font of fonts stored in at least one non-volatile memory and fonts stored in at least one volatile memory that is to be applied to the input image, and to store the font to be applied to the input image to the display memory,
wherein an amount of address data designated by the controller is less than the total amount of address data assigned to the at least one non-volatile memory and the at least one volatile memory.

35. The OSD generator as claimed in claim 34, wherein the amount of address data designated by the controller is one of the total amount of address data assigned to the one non-volatile memory and the total amount of address data assigned to the one volatile memory.

36. The OSD generator as claimed in claim 35, wherein the amount of address data designated by the controller is 1 byte.

37. The OSD generator as claimed in claim 34, wherein the controller controls a portion of basic fonts stored in the non-volatile memory and a portion of additional fonts stored in the program memory to be copied to the volatile memory, and designates a volatile memory address for the font to be applied to the input image and thereby stores the font to the display image.

38. The OSD generator as claimed in claim 34, wherein the controller establishes a virtual memory by integrating a part of storing areas of the non-volatile memory with a part of storing areas of the volatile memory, and designates a virtual memory address for the font to be applied to the input image and thereby stores the font to the display memory.
